(19) United States
(12) Patent Application Publication
(10) Pub. No.: US 2008/0172938 A1
(43) Pub. Date: Jul. 24, 2008

(54) Automatic sprout vending machine

(76) Inventor: Sidney S. Azoulay, Pahrump, NV (US)

Correspondence Address: FRANK J. MCGUE, 10801 N. 32ND STREET SUITE 5, PHOENIX, AZ, 85028, US

(21) Appl. No.: 11/655,523

(22) Filed: Jan. 19, 2007

(51) Int. Cl. A01G 9/26

(52) U.S. Cl. 47/61; 47/66.1; 47/66.7; 47/79; 700/244; 700/299

(57) ABSTRACT

This invention is an automatic sprout vending machine which provides racks for seeds to rest upon for automatically sprouting or germinating such seeds. In one embodiment, the automatic sprout vending machine comprises a housing having, preferably, an upper compartment, a lower compartment and a middle section. The middle section has a plurality of racks which are adapted to slidably receive and release a corresponding plurality of modules. In this embodiment, each of the plurality of modules includes at least on seed germinating tray having seeds mounted in the bottom thereof.

### TECHNICAL FIELD

This invention relates to equipment for automatically sprouting or germinating seeds, growing micro-green and mesclun and, more particularly, to a vending machine which automatically sprouts and grow produce or germinates seeds in a retail store such as a health food store or juice bar or a home operation to supply local markets.

### BACKGROUND OF THE INVENTION

Sprouts and greens are known to be powerfully nutritious foods yet are often forgotten on the food pyramid. The nutritional value of sprouts is well established by both nutritionists and by the scientific community. This knowledge has resulted in an increased popularity for sprouts and microgreens as foods which, in turn, has resulted in a need to have sprouts readily available to a consumer. The term “greens” relates to sprouts that are allowed to grow above the stage known as the sprouting phase. The two cotylebun leaves are fully opened and in some cases, based on the seed in question, four to six leaves are exposed.

Presently most sprouts are grown in factories and transported thousands of miles in refrigerated trucks to their destination. The conventional method of providing sprouts to the marked requires shipping and storage before the sprouts reach the consumer. Furthermore, sprouts are very delicate crops and refrigeration should be avoided as freshness is ultimate when selling the sprouts exactly when ready. Additionally, experts claim that the most effective time to consume sprouts for its nutritional benefits is around the 5^{th} day of germination, sprouted bean seeds around the 48 hours from commencement of germination.

Further, one problem with existing sprouting operations is outbreaks of food borne illnesses such as salmonella or e. coli reported to the Food and Drug Administration (FDA) from the sprout conventional fanning methods industry with resultant health risks to the consumer. The present system is designed to provide full access to the relevant authorities by providing internet access to its computerized control systems and meters monitoring all aspects of the growing process and hygiene. Thus, the authorities such as the FDA and USDA could monitor installations of the present invention throughout the country easing the workload of the need for on-site inspections. As soon as a pre-programmed parameter is out of its permissible tolerance, the system can be switched off by the inspector. Notifications of abnormalities can be communicated with the grower automatically by fax, email or cellular phone.

U.S. Pat. No. 6,442,892 entitled “Automatic Sprouter System” which issued on Sep. 3, 2002 to the present inventor, and is commonly owned by the applicant of the present application, provides a misting and oxygenating automatic sprouter system.

U.S. Pat. No. 4,144,671 entitled “Apparatus for Growing Bean Sprouts” which issued on May 20, 1979 to Lee discloses a self watering apparatus including a housing divided into an upper and a lower compartment by a horizontal divider plate having orifices therethrough. A tilting water container is used to periodically supply water to plants in the upper compartment.

U.S. Pat. No. 4,989,367 entitled “Method and Apparatus for Germinating Seed Sprouts” which issued on Feb. 5, 1991 to Chung discloses accelerated sprouting of bean sprouts by placing said sprouts in a closed vessel on a screen. The seeds are soaked with water and additives and humidified air is blown through at periodic intervals.

U.S. Pat. No. 5,025,589 entitled “Methods and Apparatus for Growing Bean Sprouts” which issued on Jun. 25, 1991 to Park discloses a series of vertical beds having bean sprouts growing therein organized in order of size with the largest at the top. Water cascades downward through the beds at periodic intervals.

However, there is still a need for a apparatus for use by the home owner or small commercial concern which is fully automatic and safely provides fresh spouts and greens to a consumer with minimal human touch. There is also a need for a more hygienic method of providing sprouts which does not require enormous resources to store and transport sprouts to the ultimate consumer thus minimizing the impact on our ecosystem. The present invention meets these needs.

None of the known prior art disclose the device set forth herein.

### SUMMARY OF THE INVENTION

It is an object of this invention to provide a fully automatic sprout growing vending machine.

The present invention is designed to provide and satisfy that need by creating a fully automated sprout growing vending machine. The present invention provides a higher hygiene standard compare to any other sprouting method. The present invention supplies a micro environment which is optimal for sprouting and growing greens.

The different functions required in the present invention are controlled by an on board computer designed for this purpose. The computer is connected online using the internet to report the status of the different functions and send alerts to a control room capable of monitoring endless installations when a function is out of its programmed tolerance. The present invention is designed for installation in the produce departments of grocery stores, in health food stores, in juice bars and other sales points.

To minimize the risk of contamination from agents such as salmonella and e. coli, the seeds used in the present invention are properly treated in a separate packing plant in accordance with FDA regulations. The seeds are fixed on the bottom of disposable cartridges by an automatic seeding machine and shipped to stores in hermetically sealed packages. The store removes the sealing skin from the cartridge from the package and inserts it inside a growing compartment of the present invention. In a few days, generally between 2 to 5 days (depend on the seed selected), and in longer periods for growing greens, the sprouts are ready for sale and are moved from the bottom growing compartment to an upper display compartment, where a shopper can select the desired sprouted cartridge.

Further, in the present invention, full control over the production of sprouts is obtained by the grower and by the control room as well as the relevant authorities via the internet connected computer. Even the FDA can monitor thousands of installations from one desk with a computer.

Since the present invention grows the sprouts in the store, the system avoids the waste inherent in the current distribution system. Thus, the present invention saves resources, energy and lessens the environmental impact since the seeds are sprouted in the same space as delivered, offering the ultimate in efficiency. There is no need to re-pack the sprouts, to provide manual labor or use expensive refrigerated shelving space at the store since the present invention occupies the same floor space for both growing and displaying the sprouts. Further, the present invention delivers the sprouts, fresh and exactly at the best time offering the ultimate in freshness.

Furthermore, sprouts are very delicate crops and refrigeration should be avoided. Since the proposed system is under a controlled environment the sprouts will carry on growing the natural way with no refrigeration until selected by a consumer. There is no rotting or molding which is presently experienced by stores with sprouts that remain a prolonged length of time on the shelf.

Further objects and advantages of the invention will become apparent as the following description proceeds and the features of novelty which characterize this invention will be pointed out with particularity in the claims annexed to and forming a part of this specification.

### BRIEF DESCRIPTION OF THE DRAWINGS

The present invention may be more readily described by reference to the accompanying drawings in which:

FIG. 1 is a front view of one embodiment of the present invention;

FIG. 2 is a side view of the embodiment of FIG. 1;

FIG. 3 is a top and front perspective view of a plurality of cartridges used in the present invention;

FIG. 4 is a side cross sectional view of still another embodiment of the present invention;

FIG. 5 is a front cross sectional view of the embodiment of FIG. 4;

FIG. 6 is a schematic of an ozone generator used in the embodiment of FIG. 4; and

FIG. 7 is a schematic of the incoming water supply used in the embodiment of FIG. 4;

### DESCRIPTION OF THE PREFERRED EMBODIMENT

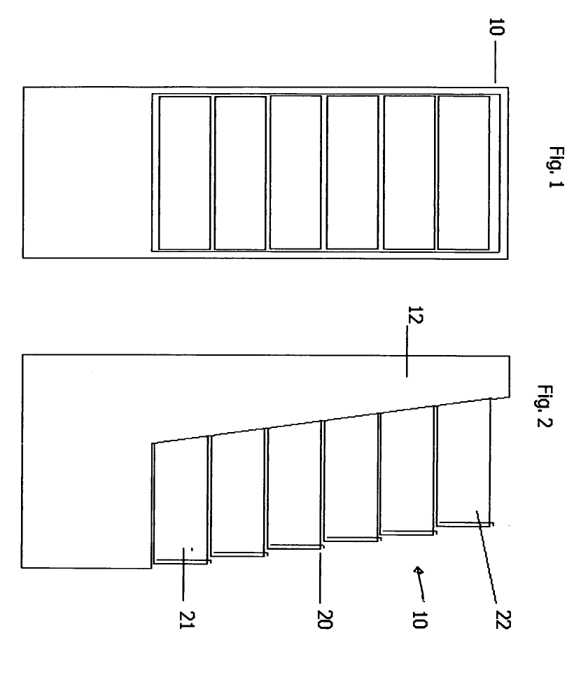

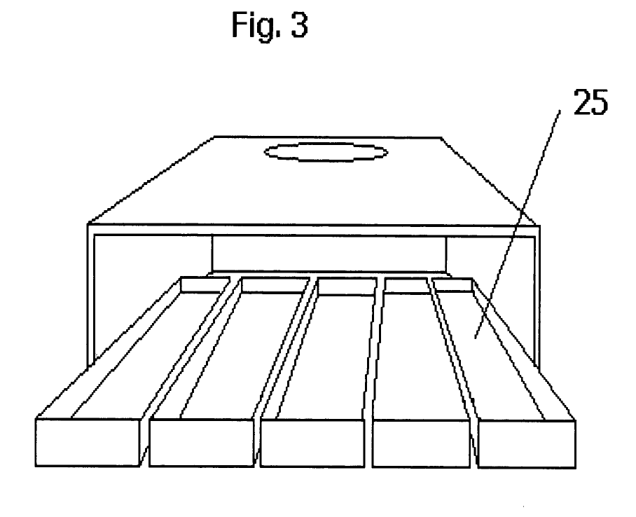

Referring more particularly to the drawings by characters of reference, FIGS. 1-2 disclose one embodiment of an automatic sprout vending machine 10. Automatic sprout vending machine 10 comprises a housing 12 having a plurality of racks 20 adapted to slidably receive and release a corresponding plurality of modules 22. In the presently preferred embodiment, each of the plurality of modules 22 is as described in applicant's U.S. Pat. No. 6,442,892 entitled “Automatic Sprouter System” which issued on Sep. 3, 2002 herein incorporated by reference.

Those skilled in the art will recognize that the invention is not limited to the patented modules 22 having enclosed mist generators. As is well known in the art, mist can be generated by misting heads, sprinklers, and foggers and distributed to trays 25 which are shown in FIG. 3. In this embodiment, seeds are fixed to the bottom of trays 25 with a preferred mixture of 20% honey and 80% gelatin though those skilled in the art will recognize that many other human friendly substances are useable and will yield similar results. Seeded trays 25 are supplied in hygienic sealed packages manufactured by seed packaging plants.

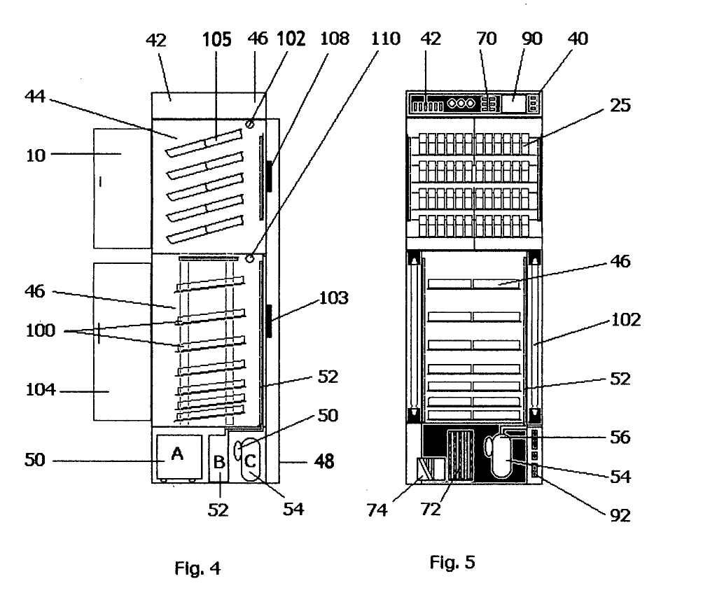

Another embodiment is best seen in FIGS. 4-5, a housing 40 includes an upper control panel 42 mounted above a display compartment 44. Display compartment 44 is positioned above a growing compartment 46 which, in turn, is positioned above a service compartment 48. Those skilled in the art will recognize that the actual positioning of each compartment is a matter of design choice, and thus the present invention is not limited to the depicted configuration.

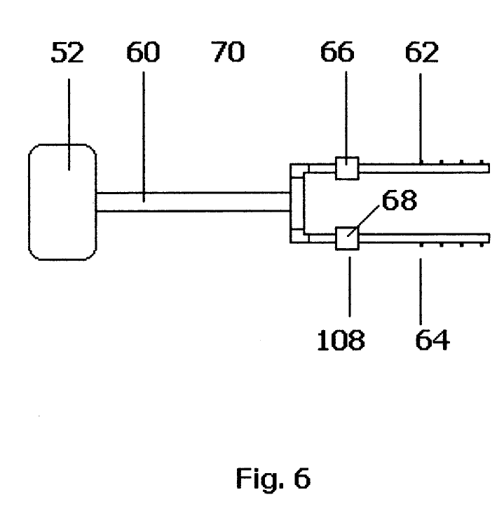

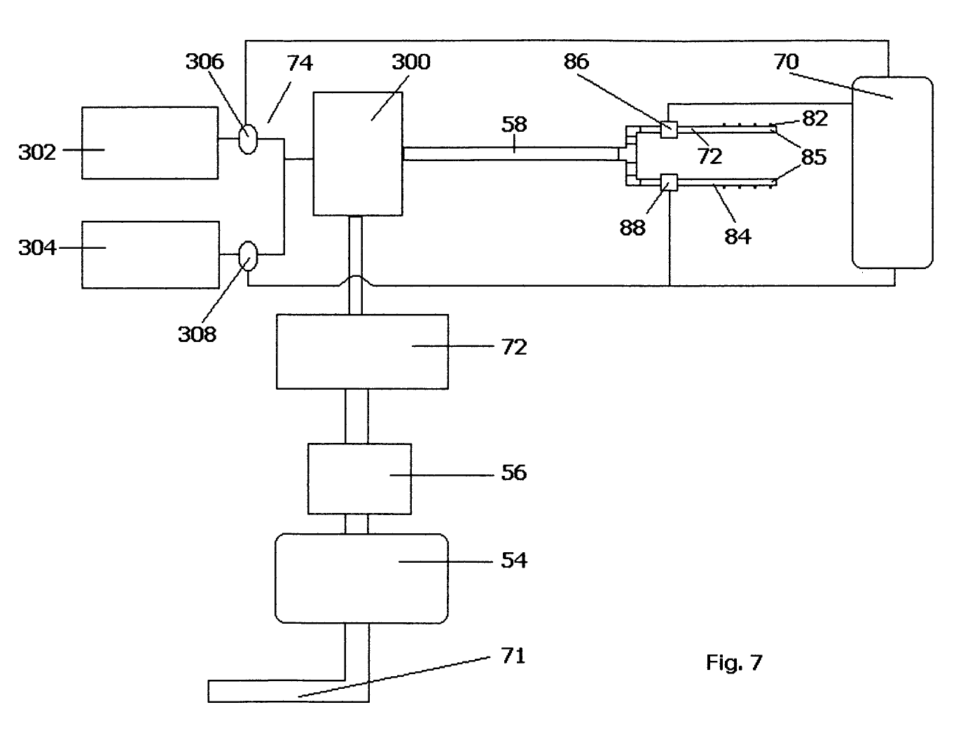

Service compartment 48 has a number of exemplary components. A drainage pan 50, preferably plastic, is used to collect drained water from housing 40. An ozone generator 52 creates the gas O³, preferably at about 0.05 parts per million (ppm) which is one of the best disinfectants for the present application. As best illustrated schematically in FIG. 6, ozone generator 52 includes a ozone feeding line 60 which splits into an growing compartment ozone feed line 62 and a display compartment ozone feed line 64. Each feed line 62, 64 includes a perforated wall which disperses the ozone within the respective compartment 46, 44. A growing compartment solenoid 66 and a display compartment solenoid 68 are in electrical communication with a computer 70 which controls the amount of ozone released in the two compartments 46, 44.

A reverse osmosis unit 54 removes substantial amounts of inorganic chemicals (salts, metals, minerals), most microorganisms, and many organic chemicals from water incoming in incoming water line 71 to housing 40. Additionally, mechanical filters and activated carbon filters 56 remove dirt, sediment and other impurities. After purification, the clean water is conveyed to a chiller unit 72 which maintains the temperature of the incoming water. Chiller unit 72 uses HFC-134a refrigerant with a sealed compressor having a full load capacity of 5 gallons.

Lastly, a injector unit 74 injects disinfectant and/or fertilizer as needed to the incoming water. In the preferred embodiment, injector 74 is a water driven pump 300 having a disinfectant tank 302 and a fertilizer tank 304 in liquid communication therewith. A disinfectant solenoid 306 and a fertilizer solenoid 308 are in electrical communication with and under the control of computer 70. The filtered, chilled and disinfected and/or fertilized water is sent to the interior of housing 40 by supply lines 58. After injector unit 74, water supply line 71 splits into an growing compartment water feed line 82 and a display compartment water feed line 84. Each feed line 82, 84 includes misters and foggers 85 which disperses the water within the respective compartment 46, 44. A growing compartment solenoid 86 and a display compartment solenoid 88 are in electrical communication with computer 70 which controls the amount of water released in the two compartments 46, 44.

In addition to ozone generator 52 and water lines 71, service compartment 48 includes a plurality of surge switches 92 which are provided to protect the electrical components of the system.

In the illustrated embodiment, directly above service compartment 48 is growing compartment 46 which includes tilted racks 100 adapted to receive a plurality of cartridges 25. Racks 100 are tilted to allow for proper drainage from each cartridge 25. Growing compartment 46 receives seeded cartridges 25 and, over the course of two (for use with mung, soy, lentil, green peas) to five days (for use with alfalfa, clover, broccoli, Chinese cabbage, radish), is used to grow the sprouts. Ultraviolet lights 102, preferably low pressure mercury arc lamps, are mounted therein to provide appropriate lighting for the growth of sprouts. Such lights 102 has germicidal properties and kills pathogens within housing 12 while leaving no toxic residuals. An extractor fan 103 pulls air from growing compartment 46 and is actuated by a humidity sensor to maintain the appropriate humidity levels inside growing compartment 46. Growing compartment 46 is provided with a metal front loading door 104 for loading new cartridges 25 therein, moving cartridges 25 within growing compartment 46 and then removing sprouted cartridges 25 to display compartment 44. Humidity sensors 110 are provided in electrical communication with computer 70 to maintain appropriate humidity levels within growing compartment 46.

In the illustrated embodiment, directly above growing compartment 46 is display compartment 44 which also includes racks 105 adapted to receive a plurality of cartridges 25. In the preferred embodiment racks 105 are forwardly tilted for drainage. Also, racks 105 are preferably tilted more than racks 100 to better display the sprouts within each cartridge 25 to a customer. A second extractor fan 108 pulls air from display compartment 44 and is actuated by a humidity sensor 110 to maintain the appropriate humidity levels therein. Display compartment 44 is provided with transparent front loading door 109 for loading sprouted cartridges 25 therein and removing cartridges 25 for purchase. Humidity and temperature sensors 110 are provided in electrical communication with computer 70 to maintain appropriate humidity levels within display compartment 44.

In the illustrated embodiment, control panel 42 is mounted atop display compartment 44. Control panel 42 includes computer 70 and controls 90 therefore. Control panel 42 provides points of regulation and control of such functions as the timers 42 for control of mist generators 23 are activated and deactivated, controls 44 for operation of ozone generators 30 and the operation of ultraviolet lights 102, operation of reverse osmosis unit 54, control of chiller unit 72 and injector unit 74, the rotational speed of mist generators and usage frequency including high speed mists and oxygenation or low speed oxygenation only, the disinfecting or fertilizer injectors 74 and the disinfecting or fertilizing cycles, artificial lighting on or off. In addition, control panel 40 includes numerous monitor gauges for temperature, humidity, water pH, water temperature, amount of ozone in air, amount of fertilizer in water in (PPM), amount of disinfecting material in water (PPM), status of periodic disinfecting cycle, electric supply status, water pressure and an automatic inspection of drained water in drainage pan 50 for detection of possible harmful bacteria.

In the preferred embodiment, manual overrides are provided on control panel 42 whereby on, for example, a weekly basis, a disinfecting cycle is initiated whereby all cartridges 25 are removed from housing 12. A disinfecting solution is injected by injectors 74 to thoroughly clean and disinfect the interior of housing 12 in about 30 minutes. Cartridges 25 are replaced after the cycle is completed.

Lastly, computer 70 is provided which is, preferably, connected to the internet and includes software allowing outside parties to generate status reports on machine 10 from anywhere. Further, in the most preferred embodiment, the software can perform its own status checks on machine 10 and report abnormalities to appropriate personnel for correction of the problem. These checks can be made daily or weekly as desired. Further, the results of such checks can be forwarded or accessed by a regulatory agency such as the Food and Drug Administration (FDA).

Although only certain embodiments have been illustrated and described, it will be apparent to those skilled in the art that various changes and modifications may be made therein without departing from the spirit of the invention or from the scope of the appended claims.

For example, large trays can be used to germinate seeds within apparatus 10 with subsequent movement to net pockets when sprouting. Also, apparatus 10 can be modularized whereby a single water compartment can be shared between a number of plant compartments sharing the same solution. Lastly, the method and concept technology are suitable for growing mini-vegetables, herbs and other product items.

That which is claimed is:

1. An automatic sprout vending machine for growing and vending sprouts to consumers, the automatic sprout vending machine comprising:
a housing having a service compartment, a growing compartment and a display compartment,
the growing compartment and the display compartment each having a plurality of racks adapted to received a corresponding plurality of modules, each of the corresponding plurality of modules having sprouts contained therein,
the service compartment having the mechanical, electrical and plumbing components necessary to operation of the sprout vending machine, said components being selected from a group comprising wherein the points of regulation are selected from a group comprising a drainage pan to collect drained water from the housing, an ozone generator creates the gas O³ and feeds the ozone to the growing compartment and the display compartment for disinfection, a reverse osmosis unit for removing inorganic chemicals, microorganisms, and organic chemicals from an incoming water line, one or more mechanical filters and activated carbon filters in the incoming water line to remove dirt, sediment and other impurities, a chiller unit to maintain the temperature of the incoming water line, an injector unit to inject disinfectant and fertilizer as needed to the incoming water line, and a plurality of surge switches to protect the electrical components of the system.

2. The automatic sprout vending machine of claim 1 wherein each of the plurality of modules includes a mist generator for providing nutrients to the sprouts contained therein.

3. The automatic sprout vending machine of claim 1 wherein the housing having mist generators mounted therein for distributing mist to each of the corresponding plurality of modules for providing nutrients to the sprouts contained therein.

4. The automatic sprout vending machine of claim 1 wherein each module contains one or more trays, each tray being provided in hygienic sealed packages with sees fixed to the bottom thereof by a nutrient mixture.

5. The automatic sprout vending machine of claim 1 wherein the housing further includes a control panel, the control panel including a computer in electrical communication with points of regulation and measuring instruments to provide optimum growing conditions for the sprouts contained therein.

6. The automatic sprout vending machine of claim 5 wherein the points of regulation are selected from a group comprising mist generator timers, ozone generator operations, ultraviolet light operations, reverse osmosis operation, chiller unit operation, disinfecting injector cycle and operations, fertilizer injector cycle and artificial lighting operations.

7. The automatic sprout vending machine of claim 5 wherein the measuring instruments are selected from a group comprising monitor gauges for temperature, humidity, water pH, water temperature, amount of ozone in air, amount of fertilizer in water in (PPM), amount of disinfecting material in water (PPM), status of periodic disinfecting cycle, electric supply status, water pressure and an automatic inspection of drained water in drainage pan 50 for detection of possible harmful bacteria.

8. The automatic sprout vending machine of claim 5 having a disinfecting cycle wherein all modules are removed from the housing and a disinfecting solution is injected to thoroughly clean and disinfect the interior of the housing, the modules being replaced after the disinfecting cycle is complete.

9. The automatic sprout vending machine of claim 5 wherein the computer is connected to the internet and includes software allowing outside parties to generate status reports on the operation thereof.

10. The automatic sprout vending machine of claim 5 wherein the computer is programmed to monitor its operations and report abnormalities to appropriate personnel via electronic means.

11. The automatic sprout vending machine of claim 1 wherein the racks are tilted to allow proper drainage from of the plurality of modules.

12. The automatic sprout vending machine of claim 1 wherein the growing compartment receives modules and retains said modules for time needed to grow the sprouts contained therein, the modules being moved to the display compartment once the sprouts have grown.
